(19) United States
(12) Patent Application Publication
(10) Pub. No.: US 2019/0089289 A1
(43) Pub. Date: Mar. 21, 2019

(54) ELECTRIC MOTOR WITH INDEPENDENT POLE CONTROL

(71) Applicant: Sikorsky Aircraft Corporation, Stratford, CT (US)

(72) Inventors: Igor Cherepinsky, Sandy Hook, CT (US); Frederick L. Bourne, Litchfield, CT (US)

(21) Appl. No.: 15/711,769

(22) Filed: Sep. 21, 2017

(51) Int. Cl. H02P 29/032; H02K 1/14; H02P 6/185

(52) U.S. Cl. CPC H02P 29/032; H02P 2101/30; H02P 6/185; H02K 1/14

(57) ABSTRACT

An electric motor includes a rotor assembly including a component rotatable about an axis and a stator assembly including a plurality of poles positioned adjacent the rotor assembly. Each of the plurality of poles is independently controllable to provide torque and speed control to the electric motor.

### BACKGROUND

The present disclosure relates to a rotary wing aircraft, and more particularly, to a rotary wing aircraft having an electric propulsion system.

Conventional rotary-wing aircraft typically utilize a mechanical drive train to transmit power from one or more engines to drive main and tail rotor systems. The helicopter mechanical drive train may include a main rotor gearbox, an intermediate gearbox, a tail rotor gearbox and their inter-connecting shafts. The main rotor gearbox converts the high speed input from each engine to a low speed output for the main rotor system. The main rotor gearbox may also provide power take-offs to drive an anti-torque system, a hydraulic system and other such systems. Elimination of the main gearbox and hydraulic systems may result in a significant reduction in aircraft weight and maintenance requirements.

### BRIEF DESCRIPTION

According to an embodiment, an electric motor includes a rotor assembly including a component rotatable about an axis and a stator assembly including a plurality of poles positioned adjacent the rotor assembly. Each of the plurality of poles is independently controllable to provide torque and speed control to the electric motor.

In addition to one or more of the features described above, or as an alternative, in further embodiments wherein performance of the electric motor is maintained when one or more of the plurality of poles fails.

In addition to one or more of the features described above, or as an alternative, in further embodiments a plurality of magnets are mounted about a periphery of the component rotatable about the axis.

In addition to one or more of the features described above, or as an alternative, in further embodiments a polarity of the plurality of magnets alternates about the periphery of the component rotatable about the axis.

In addition to one or more of the features described above, or as an alternative, in further embodiments wherein the plurality of magnets are permanent magnets.

In addition to one or more of the features described above, or as an alternative, in further embodiments the plurality of poles are generally arranged within a plane.

In addition to one or more of the features described above, or as an alternative, in further embodiments the plurality of poles are arranged within multiple planes, the multiple planes being generally parallel.

In addition to one or more of the features described above, or as an alternative, in further embodiments the plurality of poles includes ten or more poles.

In addition to one or more of the features described above, or as an alternative, in further embodiments comprising a force generator coil and an electronic control unit operably coupled to the force generator coil to selectively supply power to the force generator coil to generate the magnetic field.

In addition to one or more of the features described above, or as an alternative, in further embodiments the force generator coil includes a coil that produces a magnetic field proportional to a current provided thereto by the electronic control unit.

In addition to one or more of the features described above, or as an alternative, in further embodiments the electronic control units of each of the plurality of poles are arranged in communication via at least one data bus.

In addition to one or more of the features described above, or as an alternative, in further embodiments each of the plurality of poles determines a position of the rotor assembly.

In addition to one or more of the features described above, or as an alternative, in further embodiments each of the plurality of poles further comprises a pole position sensor for sensing a polarity of the rotor assembly adjacent the pole position sensor.

In addition to one or more of the features described above, or as an alternative, in further embodiments the pole position sensor is operably coupled to the electronic control unit, the electronic control unit determines a position of the rotor assembly in response to the sensed polarity of the rotor assembly adjacent the pole position sensor.

In addition to one or more of the features described above, or as an alternative, in further embodiments the component rotatable about an axis is associated with a rotor system of an aircraft.

In addition to one or more of the features described above, or as an alternative, in further embodiments the electric motor is integrated into a rotor system of an aircraft.

According to another embodiment, a method of operation an electric motor including a plurality of independently controllable stator poles includes energizing a force generator coil of each of the plurality of independently controllable stator poles in response to a demand of a control system, detecting a failure of at least one of the plurality of independently controllable stator poles, and adjusting one or more parameters for energizing the force generator coil of an operational portion of the plurality of independently controllable stator poles in response to a demand of a control system. Operation of the motor via only the operational portion of the plurality of the independently controllable stator poles does not result in a degradation of performance of the electric motor.

In addition to one or more of the features described above, or as an alternative, in further embodiments comprising sensing a position of a rotor of the electric motor at each of the plurality of independently controllable stator poles.

In addition to one or more of the features described above, or as an alternative, in further embodiments sensing a position of a rotor of the electric motor further comprises sensing a polarity of the rotor adjacent each of the plurality of independently controllable stator poles and determining a position of the rotor using an electronic control unit, in response to the sensed polarity.

In addition to one or more of the features described above, or as an alternative, in further embodiments operation of the electric motor drives a rotor system of an aircraft about an axis of rotation.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic diagram of an example of a vertical takeoff and landing (VTOL) rotary wing aircraft; and

FIG. 2 is a schematic diagram of an electric motor according to an embodiment.

### DETAILED DESCRIPTION

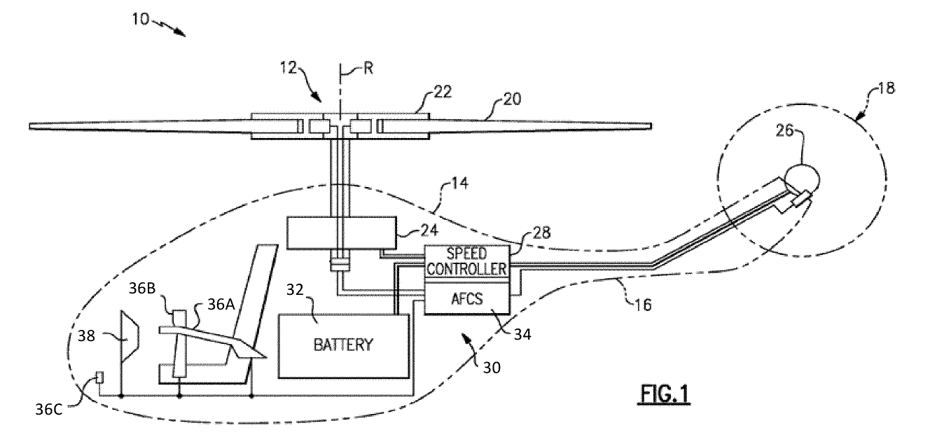

FIG. 1 schematically illustrates an example of a vertical takeoff and landing (VTOL) rotary wing aircraft 10. The aircraft 10 in the non-limiting embodiment of FIG. 1 includes a main rotor system 12 supported by an airframe 14 having an extending tail 16 which mounts an anti-torque system 18 such as a tail rotor system. The main rotor system 12 includes a plurality of rotor blades 20 mounted to a rotor hub 22 and configured to rotate about an axis of rotation R. Although a particular helicopter configuration is schematically illustrated in the disclosed non-limiting embodiments, other configurations and/or machines, such as Unmanned Air Vehicles, high speed compound rotary wing aircraft with supplemental translational thrust systems, dual counter-rotating, coaxial rotor system aircraft, tilt-rotors and tilt-wing aircraft in either manned or unmanned configurations will also benefit here from.

The main rotor system 12 is driven about an axis of rotation R through an electric motor 24 such as a high torque, low speed electric motor. The electric motor 24 may directly drive the main rotor system 12 without a main rotor gearbox. A secondary electric motor 26 within the extending tail 16 direct drives the anti-torque system 18. The electric motors 24, 26 may be controlled by an electronic speed controller 28 over a wide range of speeds in response to a flight control system 30. Power for the electric motors 24, 26 may be supplied by an on-board power source 32 such as a battery, hybrid source of electricity or such like. It should be understood that various power sources may be alternatively or additionally provided.

In an embodiment, a flight control system 30 generally includes an automatic flight control system (AFCS) 34 in communicating with other avionics systems and components such as the electronic speed controller 28, a collective controller 36A, a cyclic controller 36B, a yaw controller 36C and a cockpit instrument display system 38. It should be understood that at least some of these subsystems need not be provided in some embodiments, such as when the aircraft is an Unmanned Air Vehicle (UAV) for example.

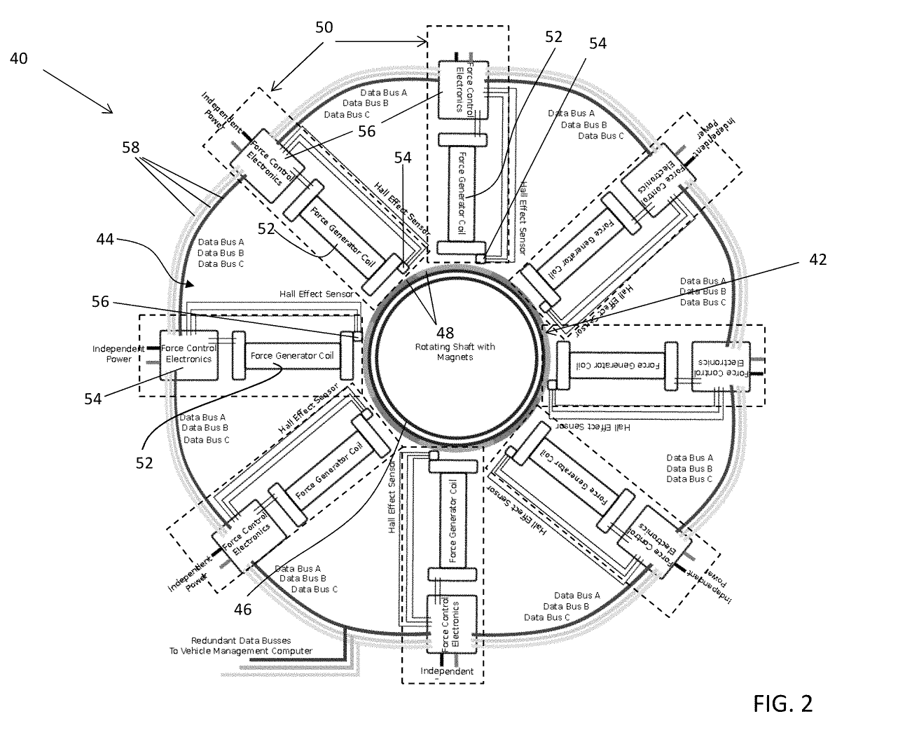

With reference now to FIG. 2, an electric motor 40, which may be implemented as the electric motor 24 associated with the main rotor system 12 and/or the electric motor 26 associated with the tail rotor system 18 of a rotary wing aircraft 10 for example, is illustrated in more detail. The motor 40 may be a separate component connect to a rotor system or may be integrated into the rotor itself. In the illustrated, non-limiting embodiment, the electric motor 40 is an induction motor including a rotor assembly 42 and a stator assembly 44. The rotor assembly 42 includes a rotating shaft 46 positioned at a center of the motor 40. The rotating shaft 46 may be a shaft or other rotating component of the corresponding rotor system 12, 18, or alternatively, may be a separate shaft directly or indirectly coupled to a shaft of the rotor system being driven by the motor.

A plurality of magnets 48 is fixedly or removably mounted to the shaft. As shown, the magnets 48 are generally circumferentially positioned about shaft. The magnets 48 may, but need not be, equidistantly spaced about the shaft 46. The plurality of magnets 48 may be connected to a ring, concentric and configured to rotate with the shaft 46. Alternatively, the magnets 48 may be coupled directly to the shaft 46. In an embodiment, the magnets 48 are arranged such that the polarity of adjacent magnets 48 alternates about the periphery of the shaft 46. Although eight magnets 48 are shown in the FIG, a motor 40 having two or more magnets 48 is contemplated herein. The magnets 48 are shown in the illustrated, non-limiting embodiment as permanent magnets; however, it should be understood that any suitable type of magnet is within the scope of the disclosure.

The stationary stator assembly 44 of the electric motor 40 includes a plurality of poles 50 affixed generally adjacent the rotor 42. The plurality of poles 50 are arranged circumferentially about the shaft 46 and are generally located at a position spaced radially outward from the shaft 46, such as in alignment with the plurality of magnets 48 for example. Although the poles 50 are illustrated as being equidistantly spaced about the shaft 46, such positioning of the poles 50 is not required.

The total number of poles 50 included in the motor 40 may vary based on the desired performance of the system coupled thereto. Two poles 50 are necessary to operate the motor and drive the rotor assembly 42 about its axis of rotation. Inclusion of one or more additional poles 50 provides redundancy to maintain operability of the motor 40 in the event of a failure of one of the poles 50. The total number of poles 50 of the stator assembly 44 may, but need not, be equal to the total number of magnets 48 of the rotor assembly 42. In the illustrated, non-limiting embodiment, the stator assembly 44 includes eight poles 50. However, embodiments having two or more poles 50 are contemplated herein. In some embodiments, for example in embodiments where the motor 40 is intended for use in high torque low speed applications, the motor has ten or more poles 50.

The plurality of poles 50 of the stator assembly 44 may be arranged within a single plane, as shown in FIG. 2, or alternatively, may be arranged within multiple planes. In such embodiments, the poles 50 within each plane are grouped to form a stator disc. Accordingly, the stator assembly may include a single stator disc or a plurality of stacked stator discs. The total number and configuration of the poles 50 associated with each stator disc may be the same, or alternatively, may vary. Further, in embodiments containing poles 50 arranged within multiple planes, the multiple planes may be generally parallel.

Each pole 50 of the stator assembly 44 includes a force generator coil 52, such as an electromagnetic coil or a solenoid for example, and an electronic control unit 54 operably coupled to the force generator coil 52 to selectively supply power thereto. Accordingly, each of the force generator coils 52 of the motor 40 may be independently operated and controlled. Each pole 50 of the motor 40 additionally includes a sensor 56 operably coupled to a corresponding electronic control unit 54. The sensor 56 is positioned within the clearance defined between an end of the force generator coil 52 and the magnets 48 mounted to the shaft 46. In an embodiment, the sensor 56 is a pole position sensor or a Hall Effect sensor configured to detect the polarity of an adjacent magnet 48 and therefore the position of the rotor assembly 42. In response to receiving a signal indicating the sensed polarity, the electronic control unit 54 will determine or adjust the energy to be supplied to the force generator coil 52. The electromagnetic coil is therefore configured to produce a magnetic field proportional to the current provided by the electronic control unit 54, where the electronic control unit 54 includes a microprocessor for computing an appropriate drive waveform based on demanded torque and sensed magnet position. With this configuration, each pole 50 of the motor 40 is capable of determining a position of the rotor and independently processing an optimal magnetic field control.

The electronic control units 54 of the plurality of poles 50 are arranged in communication with one another. For example, each of the electronic control units 54 may be operably coupled to at least one data bus 58. In the illustrated, non-limiting embodiment, each of the electronic control units 54 is connected to multiple data buses 58. Inclusion of multiple data buses 58 provides redundancy to the electric motor 40 in the event of a failure of one of the data buses 58.

The rotor assembly 42 is configured to rotate with respect to the stator assembly 44 as the magnets 48 of the rotor assembly 42 react with an induced magnetic field generated when the force generator coils 52 of the stator assembly 44 are energized. The motor electronic control unit 54 of each pole 50 is operable to control application of electrical energy and signal to each of the corresponding stationary force generator coils 52, thereby providing torque and speed control to the motor. If a failure occurs at one or more of the poles 50, the electronic control units 54 of the remaining poles 50 are configured to adjust operation thereof to compensate for the lost poles 50 and meet the power demands of the system, such as dictated by the flight control computer. For example, if a failure of one of the poles 50 occurs, the electronic control units 54 of the functioning poles will adjust the power supplied to the force generator coils 52 to maintain the torque at a desired level. As a result, a failure of one or more poles 50 will not result in any degradation of the performance of the electric motor 40.

By incorporating rotor position sensing and magnetic control at each pole 50 of the electric motor 40, the reliability of several motors is captured within a single mechanical assembly. Further, inclusion of a plurality of poles 50 eliminates the need for a step down transmission configured to reduce the speed of the rotor.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. An electric motor comprising:
a rotor assembly including a component rotatable about an axis,
a stator assembly including a plurality of poles positioned adjacent the rotor assembly, each of the plurality of poles being independently controllable to provide torque and speed control to the electric motor.

2. The electric motor of claim 1, wherein performance of the electric motor is maintained when one or more of the plurality of poles fails.

3. The electric motor of claim 1, wherein a plurality of magnets are mounted about a periphery of the component rotatable about the axis.

4. The electric motor of claim 3, wherein a polarity of the plurality of magnets alternates about the periphery of the component rotatable about the axis.

5. The electric motor of claim 3, wherein the plurality of magnets are permanent magnets.

6. The electric motor of claim 1, wherein the plurality of poles are generally arranged within a plane.

7. The electric motor of claim 1, wherein the plurality of poles are arranged within multiple planes, the multiple planes being generally parallel.

8. The electric motor of claim 1, wherein the plurality of poles includes ten or more poles.

9. The electric motor of claim 1, wherein each of the plurality of poles further comprises:
a force generator coil; and
an electronic control unit operably coupled to the force generator coil to selectively supply power to the force generator coil to generate the magnetic field.

10. The electric motor of claim 9, wherein the force generator coil includes a coil that produces a magnetic field proportional to a current provided thereto by the electronic control unit.

11. The electric motor of claim 9, wherein the electronic control units of each of the plurality of poles are arranged in communication via at least one data bus.

12. The electric motor of claim 9, wherein each of the plurality of poles determines a position of the rotor assembly.

13. The electric motor of claim 12, wherein each of the plurality of poles further comprises a pole position sensor for sensing a polarity of the rotor assembly adjacent the pole position sensor.

14. The electric motor of claim 13, wherein the pole position sensor is operably coupled to the electronic control unit, the electronic control unit determines a position of the rotor assembly in response to the sensed polarity of the rotor assembly adjacent the pole position sensor.

15. The electric motor of claim 1, wherein the component rotatable about an axis is associated with a rotor system of an aircraft.

16. The electric motor of claim 1, wherein the electric motor is integrated into a rotor system of an aircraft.

17. A method of operation an electric motor including a plurality of independently controllable stator poles, the method comprising:
energizing a force generator coil of each of the plurality of independently controllable stator poles in response to a demand of a control system;
detecting a failure of at least one of the plurality of independently controllable stator poles;
adjusting one or more parameters for energizing the force generator coil of an operational portion of the plurality of independently controllable stator poles in response to a demand of a control system, wherein operation of the motor via only the operational portion of the plurality of the independently controllable stator poles does not result in a degradation of performance of the electric motor.

18. The method of claim 17, further comprising sensing a position of a rotor of the electric motor at each of the plurality of independently controllable stator poles.

19. The method of claim 18, wherein sensing a position of a rotor of the electric motor further comprises:
sensing a polarity of the rotor adjacent each of the plurality of independently controllable stator poles; and
determining a position of the rotor using an electronic control unit, in response to the sensed polarity.

20. The method of claim 17, wherein operation of the electric motor drives a rotor system of an aircraft about an axis of rotation.
